(19) United States
(12) Patent Application Publication
(10) Pub. No.: US 2025/0217800 A1
(43) Pub. Date: Jul. 3, 2025

(54) Method, Program, and Apparatus for Controlling Access to a Distributed Shared Ledger

(71) Applicant: Xero Limited, Te Aro, Wellington (NZ)

(72) Inventors: Nicholas Halley, Te Aro, Wellington (NZ); Arun Venkatram, Te Aro, Wellington (NZ)

(21) Appl. No.: 18/852,196

(22) PCT Filed: Feb. 16, 2023
(86) PCT No.: PCT/NZ2023/050013

§ 371 Date: Sep. 27, 2024

(30) Foreign Application Priority Data
Mar. 31, 2022 (AU) 2022900851

(51) Int. Cl. G06Q 20/38; G06Q 20/40

(52) U.S. Cl. CPC G06Q 20/389; G06Q 20/401

(57) ABSTRACT

Computer-implemented methods for controlling access to a permissioned blockchain are described. A method includes receiving, from a read-only requester entity, a read-only access request, being a request for registration as a read-only blockchain user; determining whether or not to allow the read-only request, and in response to determining to allow the read-only request, registering the read-only requester entity as a read-only blockchain user, having permission to read data from the permissioned blockchain in the absence of permission to write data to the permissioned blockchain, wherein the permissioned blockchain is a financial transaction ledger recording payments between payment participants in exchange for goods or services.

### TECHNICAL FIELD

Embodiments are in the field of technology for storing and accessing data. In particular, embodiments relate to storing data in a blockchain and controlling access thereto.

### BACKGROUND

In recent years blockchain technology has become popular as a mechanism for storing and sharing definitive versions of data. Blockchains are a shared, immutable ledger. So they provide a definitive record of events, such as transactions.

Blockchains store data blockwise, wherein each block comprises one or more ledger entries. The full blockchain is distributed around blockchain members who act both as publishers (i.e. they can write to the blockchain) and subscribers (i.e. they receive and maintain copies of the blocks).

Owing to the immutable nature of blockchains, they have particular utility in the context of financial transactions, in which financial transaction ledgers are maintained as blockchains so that blockchain members can publish new financial transactions to the blockchain and receive replicated versions of the blockchain.

### SUMMARY

Embodiments of an aspect include a computer-implemented method for controlling access to a permissioned blockchain, comprising: receiving, from a read-only requester entity, a read-only access request, being a request for registration as a read-only blockchain user; determining whether or not to allow the read-only request, and in response to determining to allow the read-only request, registering the read-only requester entity as a read-only blockchain user, having permission to read data from the permissioned blockchain in the absence of permission to write data to the permissioned blockchain, wherein the permissioned blockchain is a financial transaction ledger recording payments between payment participants in exchange for goods or services. A blockchain is a distributed shared ledger.

Optionally, the method further comprises receiving, from one or more read write requester entities, one or more respective read write access requests, each read write access request being a request for registration as a read and write blockchain user; determining whether or not to allow each read write access request, and in response to determining to allow a read write access request, registering the respective read write requester entity as a read and write blockchain user, having permission to read data from the permissioned blockchain and permission to write data to the permissioned blockchain.

Optionally, the read and write requester entities include a point-of-sale system, the point-of-sale system being a distributed multi-user system, providing a mechanism for system users to accept payments from customers in exchange for goods or services provided by the system users to the customers; the point-of-sale system being registered as a read and write blockchain user of the permissioned blockchain and being configured to record in the financial transaction ledger the accepted payments between the customers and the system users as payment participants.

Optionally, the read write requester entities include a financial institute maintaining financial accounts holding currency on behalf of account holding entities, via which financial accounts account holding entities enter into transactions as a payer entity transferring currency from a respective financial account to a payee entity, or as a payee entity receiving currency into a respective financial account from a payer entity; the financial institute being registered as a read and write blockchain user of the permissioned blockchain.

Optionally, the read-only blockchain user is an accounting system, having a user in common with the point-of-sale system; the read-only request specifies a monitored entity, the monitored entity being a user of the accounting system; and in response to determining to allow the read-only request, the read-only requester entity is registered as a read-only blockchain user for the monitored entity, the registration granting the read-only requester entity permission to read data from the financial transaction ledger regarding transactions in which the monitored entity is recorded as a payment participant.

Optionally, the method further comprises adding a new block to the financial transaction ledger recording a new payment between payment participants; comparing the payment participants for the new payment with registered monitored entities of read-only blockchain users to determine that a payment participant is the monitored entity for a particular read-only blockchain user; notifying the particular read-only blockchain user of the new payment.

Optionally, the method further comprises receiving an update request from a registered read-only blockchain user; for blocks in the permissioned blockchain having timestamps belonging to a defined time period, identifying payments recorded in the financial transaction ledger in which a payment participant is the monitored entity for the read-only blockchain user from which the update request is received; responding to the update request with a notification of the identified payments.

Optionally, the method further comprises upon registering the read-only blockchain user for a monitored entity, issuing the read-only blockchain user entity with a read-only certificate specific to the monitored entity; replicating the blockchain to read and write blockchain users and to read-only blockchain users, the financial transaction ledger of the blockchain being selectively cryptographically encrypted in the blockchain with an encryption code selected per recorded payment in dependence upon the payment participants; the read-only certificate specific to the monitored entity being configured to decrypt the financial transaction ledger to obtain a notification of recorded transactions in which the monitored entity is a payment participant, and not to decrypt the remainder of the financial transaction ledger.

Embodiments of another aspect include a computer-implemented method for accessing a permissioned blockchain, the method comprising, at a computing apparatus: transmitting, to a blockchain user registration entity operable to register users and associated permissions of the users for accessing the permissioned blockchain, a request for registration as a read-only blockchain user of the permissioned blockchain; receiving, from the blockchain user registration entity, notification of registration as a read-only blockchain user of the permissioned blockchain, wherein the permissioned blockchain is a financial transaction ledger recording payments between payment participants in exchange for goods or services.

Optionally, the computing system is an accounting system having, as a user, a payee entity in one or more payments in the financial transaction ledger; the request for registration as a read-only blockchain user of the permissioned blockchain specifying, as a monitored entity, the user; the registration granting the accounting system permission to read data from the financial transaction ledger regarding transactions in which the monitored entity is the payee entity.

Optionally, the method further comprises, at the accounting system: receiving data from the permissioned blockchain comprising transaction information representing one or more transactions in which the monitored entity is the payee entity; reconciling the transaction information with a corresponding entry or entries in a general ledger for the monitored entity maintained by the accounting system.

Embodiments of another aspect include a computer program which, when executed by a computing apparatus having memory hardware and processor hardware, causes the processor hardware to perform a method for controlling access to a permissioned blockchain, the method comprising: receiving, from a read-only requester entity, a read-only access request, being a request for registration as a read-only blockchain user; determining whether or not to allow the read-only request, and in response to determining to allow the read-only request, registering the read-only requester entity as a read-only blockchain user, having permission to read data from the permissioned blockchain in the absence of permission to write data to the permissioned blockchain, wherein the permissioned blockchain is a financial transaction ledger recording payments between payment participants in exchange for goods or services.

Embodiments of another aspect include a computer program which, when executed by a computing apparatus having memory hardware and processor hardware, causes the processor hardware to perform a method for accessing a permissioned blockchain, the method comprising: transmitting, to a blockchain user registration entity operable to register users and associated permissions of the users for accessing the permissioned blockchain, a request for registration as a read-only blockchain user of the permissioned blockchain; receiving, from the blockchain user registration entity, notification of registration as a read-only blockchain user of the permissioned blockchain, wherein the permissioned blockchain is a financial transaction ledger recording payments between payment participants in exchange for goods or services.

Embodiments of another aspect include a computing apparatus comprising memory hardware and processor hardware, the memory hardware storing processing instructions which when executed by the processor hardware, configure the processor hardware to: receive, from a read-only requester entity, a read-only access request, being a request for registration as a read-only blockchain user; determine whether or not to allow the read-only request, and in response to determining to allow the read-only request, register the read-only requester entity as a read-only blockchain user, having permission to read data from the permissioned blockchain in the absence of permission to write data to the permissioned blockchain, wherein the permissioned blockchain is a financial transaction ledger recording payments between payment participants in exchange for goods or services.

Embodiments of another aspect include a computing apparatus comprising memory hardware and processor hardware, the memory hardware storing processing instructions which when executed by the processor hardware, configure the processor hardware to: transmit, to a blockchain user registration entity operable to register users and associated permissions of the users for accessing the permissioned blockchain, a request for registration as a read-only blockchain user of the permissioned blockchain; receive, from the blockchain user registration entity, notification of registration as a read-only blockchain user of the permissioned blockchain, wherein the permissioned blockchain is a financial transaction ledger recording payments between payment participants in exchange for goods or services.

Embodiments of another aspect include a computing apparatus comprising memory hardware and processor hardware, the memory hardware storing processing instructions which when executed by the processor hardware, cause the processor hardware to perform a method of an embodiment.

Embodiments of another aspect include a computing apparatus comprising memory hardware and processor hardware, the memory hardware storing processing instructions which when executed by the processor hardware, cause the processor hardware to perform a method of an embodiment.

Advantageously, embodiments provide a mechanism to allow the blockchain data to be accessed by parties without granting those parties permission to write to the blockchain. The permission to publish new ledger entries to the blockchain can be constrained to a subset of users, with the remainder of the users having read-only access.

Embodiments enable third parties real-time access to data recorded in the ledger of a blockchain without needing to be a fully-permissioned blockchain user.

Embodiments are particularly advantageous in the context of financial transaction ledgers in which only particular parties should be permissioned to record new transactions into the ledger, but a broader selection of parties have legitimate interest in gaining real-time access to the financial transaction ledger.

### DETAILED DESCRIPTION

Embodiments will be set out, by way of example only, with reference to the accompanying drawings, in which:

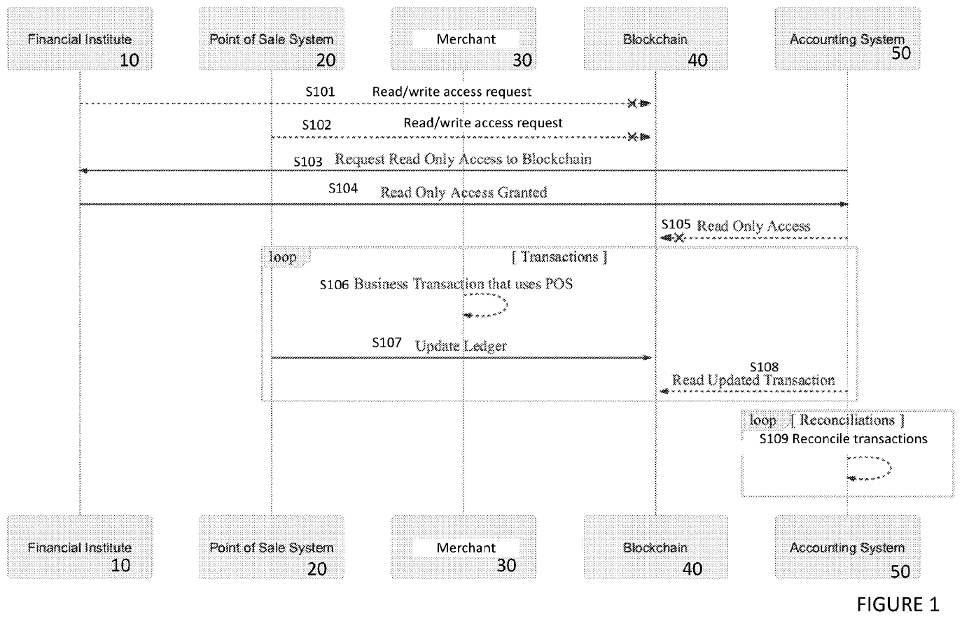

FIG. 1 illustrates exemplary messaging or communications according to an embodiment;

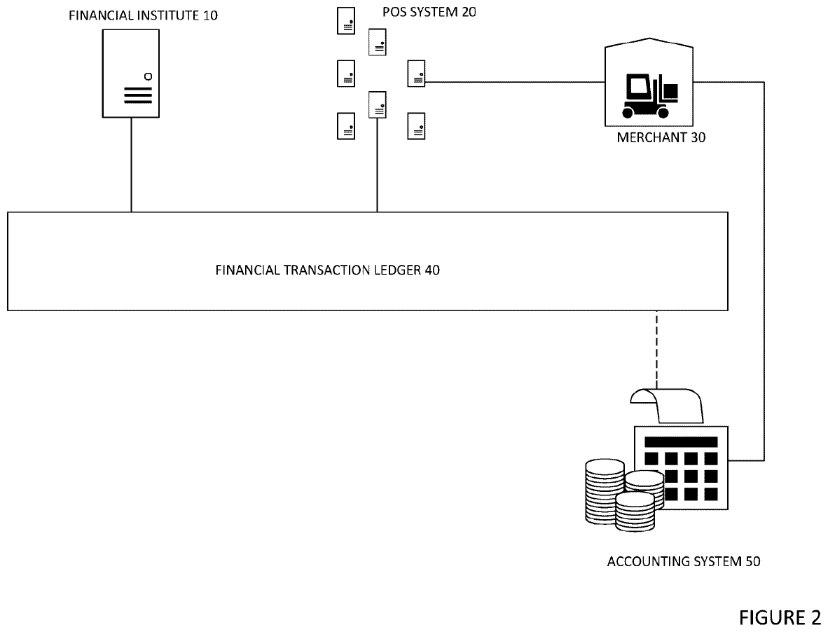

FIG. 2 illustrates a hardware architecture of parties according to an embodiment; and

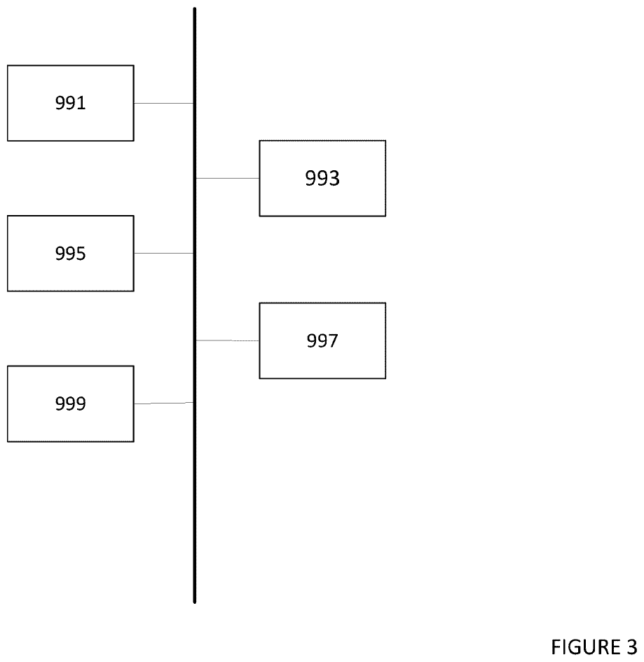

FIG. 3 illustrates a computing apparatus of an embodiment.

Five entities are illustrated in the example of FIG. 1: a financial institute 10 such as a bank; a point of sale system 20 such as a payment system provider; a merchant 30 such as a shop or service provider; a blockchain 40 which is a permissioned blockchain; and an accounting system 50.

The blockchain 40 in the example of FIG. 1 is a blockchain of a financial transaction ledger, that is, the blocks of the blockchain 40 contain data representing a financial transaction ledger.

FIG. 2 illustrates an arrangement of entities according to an embodiment. The financial transaction ledger 40 is the blockchain. The financial transaction ledger 40 is illustrated as a single entity, but may, in fact, be replicated at each read/write member, including one or more from among financial institute 10, POS system 20, merchant 30.

Embodiments may take various forms with different mechanisms for managing the blockchain 40 and with different relationships between the entities. For example, the blockchain 40 (which is a private blockchain restricting access to those entities granted appropriate permissions) may be controlled by the financial institute 10. The financial institute 10 may administer the blockchain 40 including controlling access and setting rules for reading/writing data to/from the blockchain 40. Alternatively, the blockchain 40 may be a pre-existing financial transaction ledger, to which the financial institute 10 makes a request to access as a read/write blockchain user.

The financial institute 10 may be a bank maintaining financial accounts holding currency on behalf of account holding entities, via which financial accounts account holding entities enter into transactions transferring currency from a respective financial account to a payee entity, or as a payee entity receiving currency into a respective financial account from a payer.

Whether the financial institute 10 is the controller of the blockchain 40 or a read write requester entity making a read write request as in S101, the financial institute 10 has access to the blockchain 40 and may read and/or write transaction details to/from the financial transaction ledger represented in the blockchain. Such access is illustrated by the line connecting the financial institute 10 to the financial transaction ledger 40 in FIG. 2.

The point-of-sale system 20 may be a distributed multi-user system, providing a mechanism for system users to accept payments from customers in exchange for goods or services provided by the system users to the customers. The point-of-sale system 20 may be a payment platform or other such technology facilitating payments between parties in dependence upon authorisations by the payment participants, which authorization may be a general standing authorization on the part of a payment recipient to receive payments via the payment platform and may be a specific authorization per payment on the part of a payment sender. Authorisation may be via a physical card such as a bank card, or a virtual bank card, or by some other form of authorization. In FIG. 2, the POS system 20 is illustrated as a distributed system comprising multiple individual computing apparatus. For example, the POS system 20 may comprise physical hardware at merchant sites in data communication with servers operated on behalf of the POS system 20, and/or the POS system 20 may be available to merchants 30 in the absence of any physical hardware, for example as a plugin running on a merchant website. The connection between the merchant 30 and the POS system 20 in FIG. 2 represents the use of the POS system 20 by the merchant 30 to process payments from customers.

The point-of-sale system 20 may be virtual such as a plugin or equivalent that merchants 30 (i.e. providers of goods/services) can include on their own websites to facilitate taking payments from customers. Alternatively or additionally, the point-of-sale system 20 may include hardware and software for enabling a merchant 30 to take payments from a customer in-person. In either case, payments in the context of the embodiment are taken to be transfers of funds (i.e. currency) from a financial account belonging to a customer into a financial account belonging to a merchant 30, in exchange for goods or services provided by the merchant 30. Such financial accounts may be maintained by a financial institute such as the financial institute 10.

At S102 the point of sale system 20 makes a read/write access request to the blockchain 40. This can happen in different ways depending on the particular implementation. For example, it may be that the financial institute 10 has a role as controller of the blockchain 40, in which case the request at S102 may in fact be to the financial institute 10 (of course, even in such a case, the request may be to the blockchain 40 which in turn forwards the request to the financial institute 10). In other words, the request at S102 may be processed by a centralised controller of the blockchain 40 such as the financial institute 10 to determine whether or not to permit the request. This implementation may be referred to as a centralised controller model or equivalent. The read/write access to the financial transaction ledger 40 by the POS system 20 is illustrated by the line connecting the two entities in FIG. 2.

Alternatively, the financial institute 10 may be a read write user of the blockchain 40 with equal status with one or more other read write users, who collectively receive and process the read write access request at S102 to determine whether or not to permit the request. This implementation may be referred to as a distributed controller model or equivalent.

The merchant 30 is a user, such as a subscriber, of the point-of-sale system 20. Payments taken or received by the merchant 30 via the point-of-sale system 20 are written to the blockchain 40 by the point-of-sale system 20. For example, each transaction may be a new block in the blockchain 40, or the point-of-sale system 20 may write the transactions into the blockchain 40 in batches. Since transactions are written into the blockchain 40, the blockchain 40 is effectively a financial transaction ledger, albeit in the form of a shared immutable ledger (i.e. a blockchain).

The blockchain 40 is a shared immutable ledger. The blockchain 40 is not a public blockchain. The blockchain 40 is a private blockchain, i.e. a permissioned blockchain, with access restricted to particular parties. Control of access is via a centralised controller model or a distributed controller model as set out above. The blockchain 40 may be distributed among its users. Depending on the implementation, the blockchain 40 may be shared among controller entities only, among all read write blockchain users, or among all read write users and all read-only users.

Entities with which the blockchain 40 is shared do not necessarily have access to all of the information stored in the blockchain. For example, users may have certificates with which to decrypt the blockchain 40, which certificates are tailored to enable access to specific subsets of the information. The financial institute 10 may act as a certificate authority or may appoint a certificate authority.

Should the access requests at S101 and S102 be granted, the respective requesting entities are registered as read-write users of the blockchain 40, as appropriate. For example, such registration may imply inclusion in a set of entities to which the blockchain 40 is replicated. The controlling mechanism, whether centralised or distributed, may have criteria against which to assess read write access requests. For example, authentication of originator of the request and identity of the originator as a member of a scheme or service with which the blockchain 40 is associated. For example, it may be that read/write access to the blockchain 40 is for a closed set of financial institutes 10 and/or point-of-sale systems 20 only, in accordance with a pre-existing agreement between the parties.

The accounting system 50 may be a multi-user online accounting system operating via a subscriber model whereby businesses or other users, for example merchants 30, subscribe for services offered by the accounting system 50. In particular, the accounting system 50 offers cashbook and other online ledgers for recording and categorizing financial transactions in which the user sends or receives payment. The accounting system 50 may be modular according to a membership level of the user and may provide services such as payroll management. The registration of merchant 30 as a user of an online bookkeeping service of the accounting system 50 is illustrated by the line connecting the two entities in FIG. 2.

Accounting system 50 may, for particular users, be granted access to a bank account belonging to the user and maintained on behalf of the user by a bank such as financial institute 10. A user provides login credentials to the accounting system 50 in order to set up a direct feed into the accounting system 50 of financial transaction data for financial transactions into or out of the user bank account. Such financial transaction data is reconciled via manual interaction with the accounting system 50 by the user to confirm the transaction and provide information enabling appropriate categorization and processing by the accounting system 50. Embodiments enable accounting system 50 to access financial transaction data directly from the blockchain 40 without requiring bank account access.

Accounting system 50 has a user base of merchants 30 and other businesses who use the accounting system 50 to administer their business bank accounts. The user base of the accounting system 50 may overlap the user base of the point-of-sale system 20. In other words, there may be one or more users of the accounting system 50 who are also users of the point-of-sale system 20. This embodiment will focus on a single such user, merchant 30, noting that the arrangement is scalable and not limited by the number of users.

At S103, the accounting system requests read-only access to the blockchain 40. In FIG. 1, the request is illustrated as being from the accounting system 50 to the financial institute 10. The financial institute processes the request. It is noted that in the case of a distributed controller model blockchain 40, the request may be directly to the blockchain 40 which is then automatically distributed among the read-write users of the blockchain who collectively process the request. Furthermore, it is noted that the read-only request at S103 whilst illustrated as being from the accounting system 50 may originate from the merchant 30 as a user of the accounting system 50, with the accounting system 50 providing an interface for the merchant 30 to trigger a read-only access request to the blockchain 40 by the accounting system 50. In particular, read-only request to the blockchain may be constrained to specific monitored entities, that is, rather than read-only access requests giving rise to read-only access to the entire financial transaction ledger of the blockchain 40, the read-only access requests may give rise to read-only access to transactions from the financial transaction ledger in which the specific monitored entity is a payment participant.

For example, the merchant 30 may be a user of both the point-of-sale system 20 and the accounting system 50, and therefore trigger the accounting system 50 to issue a read-only request at S103 to access transaction information from the blockchain regarding transactions in which the merchant 30 is a payment participant.

In instances in which the read-only request is triggered by the user, it may be evident in the request, for example by a token or certificate. In which case the blockchain 40 (or controlling entity) may not require further permissions to grant the request at S104. Alternatively, the processing of the request by the financial institute 10 or the users of the blockchain 40 may include polling the user (i.e. the merchant 30) for authorization to allow the accounting system 50 to register as a read-only blockchain user with read-only access to transactions from the ledger in which the said user is a payment participant.

In accordance with permission from the monitored entity specified in the request at S103 or otherwise according to a scheme for processing read-only access requests, at S104 read-only access is granted to the accounting system 50. It is noted that read-only access may not be for a specific monitored entity and may be for the entire blockchain 40. For example, since the accounting system is a trusted entity in the context of financial operations in a particular jurisdiction, there may be no issue of trust associated with granting the accounting system 50 read-only access to the entire blockchain 40 even if some users of the point-of-sale system 20 are not subscribers of the accounting system 50. The read only access to the financial transaction ledger 40 by the accounting system 50 is illustrated by the dashed line connecting the two entities in FIG. 2.

At S105 the accounting system 50 leverages the access granted at S104 to make a read-only access to the blockchain 40. Different mechanisms may be implemented for granting and controlling/managing access. For example, a register may be maintained, either centrally or in a distributed manner, which registers details of entities to which access is granted, respective access levels, and any further details for example if access is in relation to specific transaction participants only. Accessing entities may then be required (by a centralised or distributed controller) to authenticate themselves, and then be allowed access to the blockchain data in response to successful authentication. Alternatively or additionally, the centralised or distributed controller may act as a certificate authority, with the certificate being the means for authentication and allowing an entity to access the blockchain 40. The blockchain 40 may already be replicated to the accessing entity by virtue of the general replication procedure followed by the blockchain 40, or a replica may be provided on a per access request basis. For example, the blockchain 40 may be replicated to read/write users in accordance with the general replication procedure, with read-only users being required to request a replica.

If another accounting system or a financial service wanted access to the blockchain (the ledger), they could be treated as another node on the blockchain network. The blockchain network may thus be considered a consortium or hybrid blockchain network, including multiple accounting system or financial service members. The another accounting system or financial service could then use their certificate obtained from a trusted authority to have immediate read-only authorisation for the same.

Grants of access may be perpetual or may have an expiration defined in time or number of accesses. Number of accesses may be 1 or any positive integer value greater than 1.

Steps S106 to S107 illustrate a procedure for keeping the blockchain 40 up-to-date in real-time relative to financial transactions. Optional step S108 illustrates an accounting system 50 making a read-only access to the blockchain 40. Steps S106 to S107 are illustrated as part of a loop to emphasize the repetitive nature of the processing on a per transaction basis. At S106 the merchant 30, being a user of the point-of-sale system 20 that is a read/write user of blockchain 40, executes a financial transaction with a customer (not illustrated) in which the customer is transferring money to the merchant 30 in exchange for goods or services. The transaction is executed by the point-of-sale system 20 under instruction of the merchant 30 and with consent of the customer. Part of the processing executed by the point-of-sale system 20 in executing the transaction is to write to the blockchain 40 (specifically to the financial transaction ledger) transaction data representing the transaction. The transaction data is written to the blockchain 40 in the form of a block, which may be encrypted. The transaction data includes values of one or more transaction parameters, including unique ID, date stamp, transaction value, transaction payee identity, transaction payer identity, description of goods/service (wherein transaction and payment are interchangeable in this context). The transaction parameters may be accessible by blockchain users having different permissions. For example, the transaction data 40 may be decrypted such that it can only be decrypted by particular certificate holders, such as the point-of-sale system 20 and a read-only user (e.g. accounting system 50) for which the merchant 30 is listed as a monitored entity.

Optionally, since the blockchain 40 is a financial transaction ledger recording transactions executed by a point of sale system 20, the blockchain 40 may require that the accounting system 50 submit to the blockchain 40 (or the controlling entity, whether that be centralized or distributed) credentials of the monitored entity such as bank account sort code and account number and/or card number, which authenticates the accounting system 50 as an authentic service provider for the monitored entity.

One or more different mechanisms may be provided for the read accesses such as illustrated at S108. For example, a push notification mechanism (in which blockchain 40 notifies read-only user 50 of transaction in response to new relevant transaction in ledger), a pull notification mechanism (in which read-only user 50 queries a centralised/distributed controller of the blockchain 40 and new relevant transaction data is returned as a query response). The term relevant is used here to indicate an identity of a transaction participant matches a monitored entity for which the read-only user 50 is registered as a read-only user. It is noted that the read-only user 50 may be provided with an encrypted version of the complete financial transaction ledger and the read-only user 50 only has certificates enabling decryption of relevant transactions, or the distributed/centralised controller may filter transactions in the ledger for relevance and provide only relevant transaction data to the read-only user 50.

In the push notification mechanism, the processing by the read write blockchain user 20 and blockchain controller may comprise adding a new block to the financial transaction ledger recording a new payment between payment participants; comparing the payment participants for the new payment with registered monitored entities of read-only blockchain users to determine that a payment participant is the monitored entity for a particular read-only blockchain user; notifying the particular read-only blockchain user of the new payment.

In the pull notification mechanism, the processing by the blockchain controller may comprise receiving an update request from a registered read-only blockchain user; for blocks in the permissioned blockchain having timestamps belonging to a defined time period, identifying payments recorded in the financial transaction ledger in which a payment participant is the monitored entity for the read-only blockchain user from which the update request is received; responding to the update request with a notification of the identified payments.

At step S109 the accounting system 50 as a read-only user of the blockchain 40 uses the transaction data obtained from the blockchain 40, and relates to transactions involving a particular monitored entity as a transaction participant and user of the accounting system 50, to reconcile transactions. The process of reconciliation is confirming that all relevant transactions from the blockchain are recorded appropriately in the business accounting records for the payment participant as a subscriber to or user of the accounting system.

The accounting system 50 may have its own general transaction ledger, for example, recording transactions according to inputs from the user or subscriber. Wherein, for example, the inputs define parameters such as value, classification/categorization (for example according to tax expense categories in the relevant jurisdiction), and may also include date/time, transaction participants, etc. In order to confirm the transactions input to the general transaction ledger, a further source of data is required. According to embodiments, the blockchain 40 provides a real time record of transactions and so if the accounting system 50 has read access to the blockchain 40, the reconciliation of the general transaction ledger of the accounting system 50 can be performed in real time, or as soon as transactions are entered into the general transaction ledger. Therefore, the accounting system 50 can maintain an up-to-date record of the financial accounts of the user/subscriber, without needing to wait for bank statements or other confirmatory sources of data to reconcile the general transaction ledger. The transaction data that the accounting system 50 receives or retrieves from the blockchain 40 may be, for example, transaction timestamp, transaction amount, and transaction reference. With this data, a potential reconciliation may be presented to a user for a user to verify via a graphical user interface of the accounting system 50.

FIG. 3 is a schematic illustration of a hardware arrangement of a computing apparatus. The members of the blockchain such as the financial institute 10, the POS system 20, and the accounting system 50, may access and store replications of the blockchain 40 by apparatus having an arrangement such as illustrated in FIG. 3.

Embodiments may be computer programs for execution by computing apparatus and which cause the computing apparatus to execute one or more of the steps of a method disclosed herein, for example the method of FIG. 1. An embodiment may be a suite or plurality of computer programs for execution by computing apparatus comprising plural distinct individual computing devices and which cause the individual computing devices to execute one or more of the steps of a method disclosed herein, for example the method of FIG. 1. The computer programs may be stored on storage media such as computer-readable storage medium, and which may be non-transitory computer-readable storage media. For example, distinct computer programs may be provided for execution by one or more individual computing devices each implementing one of one or more from among: the financial institute 10 of FIG. 1, the point of sale system 20 of FIG. 1, the merchant 30 of FIG. 1, (a participant in) the blockchain 40 of FIG. 1, and the accounting system 50 of FIG. 1.

The computing apparatus comprises a plurality of components interconnected by a bus connection. The bus connection is an exemplary form of data and/or power connection. Direct connections between components for transfer of power and/or data may be provided in addition or as alternative to the bus connection.

The computing apparatus comprises memory hardware 991 and processing hardware 993, which components are essential regardless of implementation. Further components are context-dependent, including a network interface 995, input devices 997, and a display unit 999. The display unit 999 and the processing hardware 993 may cooperate to implement a graphical user interface.

The memory hardware 991 stores processing instructions for execution by the processing hardware 993. The memory hardware 991 may include volatile and/or non-volatile memory. The memory hardware 991 may store data pending processing by the processing hardware 993 and may store data resulting from processing by the processing hardware 993.

The processing hardware 993 comprises one or a plurality of interconnected and cooperative CPUs for processing data according to processing instructions stored by the memory hardware 991.

Embodiments may comprise one computing device according to the hardware arrangement of FIG. 3, or a plurality of such devices operating in cooperation with one another. For example, in a client: server arrangement. The POS system 20 may be realised by a distributed network of such computing apparatus.

A network interface 995 provides an interface for transmitting and receiving data over a network. Connectivity to one or more networks is provided. For example, a local area network and/or the internet. Connectivity may be wired and/or wireless.

Input devices 997 provide a mechanism to receive inputs from a user. For example, such devices may include one or more from among a mouse, a touchpad, a keyboard, an eye-gaze system, and a touch interface of a touchscreen. Inputs may be received over a network connection. For example, in the case of server computers, a user may connect to the server over a connection to another computing apparatus and provide inputs to the server using the input devices of the another computing apparatus.

A display unit 999 provides a mechanism to display data visually to a user. The display unit 999 may display user interfaces by which certain locations of the display unit become functional as buttons or other means allowing for interaction with data via an input mechanism such as a mouse. A server may connect to a display unit 999 over a network.

1. A computer-implemented method for controlling access to a permissioned blockchain, comprising:
receiving, from a read-only requester entity, a read-only access request, being a request for registration as a read-only blockchain user;
determining whether or not to allow the read-only request, and in response to determining to allow the read-only request, registering the read-only requester entity as a read-only blockchain user, having permission to read data from the permissioned blockchain in the absence of permission to write data to the permissioned blockchain, wherein
the permissioned blockchain is a financial transaction ledger recording payments between payment participants in exchange for goods or services;
the read-only blockchain user is an accounting system;
the read-only request specifies a monitored entity, the monitored entity being a user of the accounting system; and
in response to determining to allow the read-only request, the read-only requester entity is registered as a read-only blockchain user for the monitored entity, the registration granting the read-only requester entity permission to read data from the financial transaction ledger regarding transactions in which the monitored entity is recorded as a payment participant; and
the computer-implemented method further comprising:
receiving, from one or more read write requester entities, one or more respective read write access requests, each read write access request being a request for registration as a read and write blockchain user; and
determining whether or not to allow each read write access request, and in response to determining to allow a read write access request, registering the respective read write requester entity as a read and write blockchain user, having permission to read data from the permissioned blockchain and permission to write data to the permissioned blockchain

2. (canceled)

3. The computer-implemented method according to claim 1, wherein
the read and write requester entities include a point-of-sale system, the point-of-sale system being a distributed multi-user system, providing a mechanism for system users to accept payments from customers in exchange for goods or services provided by the system users to the customers; and
the point-of-sale system being registered as a read and write blockchain user of the permissioned blockchain and being configured to record in the financial transaction ledger the accepted payments between the customers and the system users as payment participants.

4. The computer-implemented method according to claim 1, wherein
the read write requester entities include a financial institute maintaining financial accounts holding currency on behalf of account holding entities, via which financial accounts account holding entities enter into transactions as a payer entity transferring currency from a respective financial account to a payee entity, or as a payee entity receiving currency into a respective financial account from a payer entity; and
the financial institute being registered as a read and write blockchain user of the permissioned blockchain.

5. (canceled)

6. The computer-implemented method according to claim 1, further comprising:
adding a new block to the financial transaction ledger recording a new payment between payment participants;
comparing the payment participants for the new payment with registered monitored entities of read-only blockchain users to determine that a payment participant is the monitored entity for a particular read-only blockchain user; and
notifying the particular read-only blockchain user of the new payment.

7. The computer-implemented method according to claim 29, further comprising:
receiving an update request from a registered read-only blockchain user;
for blocks in the permissioned blockchain having timestamps belonging to a defined time period, identifying payments recorded in the financial transaction ledger in which a payment participant is the monitored entity for the read-only blockchain user from which the update request is received; and
responding to the update request with a notification of the identified payments.

8. The computer-implemented method according to claim 1, further comprising:
upon registering the read-only blockchain user for a monitored entity, issuing the read-only blockchain user entity with a read-only certificate specific to the monitored entity;
replicating the blockchain to read and write blockchain users and to read-only blockchain users, the financial transaction ledger of the blockchain being selectively cryptographically encrypted in the blockchain with an encryption code selected per recorded payment in dependence upon the payment participants; and
the read-only certificate specific to the monitored entity being configured to decrypt the financial transaction ledger to obtain a notification of recorded transactions in which the monitored entity is a payment participant, and not to decrypt the remainder of the financial transaction ledger.

9. The computer-implemented method according to claim 1, the method further comprising, at a computing apparatus:
transmitting, to a blockchain user registration entity operable to register users and associated permissions of the users for accessing the permissioned blockchain, a request for registration as a read-only blockchain user of the permissioned blockchain; and
receiving, from the blockchain user registration entity, notification of registration as a read-only blockchain user of the permissioned blockchain, wherein
the permissioned blockchain is a financial transaction ledger recording payments between payment participants in exchange for goods or services.

10. The computer-implemented method according to claim 9, wherein
the computing apparatus is an accounting system having, as a user, a payee entity in one or more payments in the financial transaction ledger;
the request for registration as a read-only blockchain user of the permissioned blockchain specifying, as a monitored entity, the user; and
the registration granting, to the accounting system, permission to read data from the financial transaction ledger regarding transactions in which the monitored entity is the payee entity.

11. The computer-implemented method according to claim 10, further comprising, at the accounting system:
receiving data from the permissioned blockchain comprising transaction information representing one or more transactions in which the monitored entity is the payee entity; and
reconciling the transaction information with a corresponding entry or entries in a general ledger for the monitored entity maintained by the accounting system.

12. A non-transitory computer-readable medium storing a computer program which, when executed by a computing apparatus having memory hardware and processor hardware, causes the processor hardware to perform a method for controlling access to a permissioned blockchain, the method comprising:
receiving, from a read-only requester entity, a read-only access request, being a request for registration as a read-only blockchain user;
determining whether or not to allow the read-only request, and in response to determining to allow the read-only request, registering the read-only requester entity as a read-only blockchain user, having permission to read data from the permissioned blockchain in the absence of permission to write data to the permissioned blockchain, wherein
the permissioned blockchain is a financial transaction ledger recording payments between payment participants in exchange for goods or services;
the read-only blockchain user is an accounting system;
the read-only request specifies a monitored entity, the monitored entity being a user of the accounting system; and
in response to determining to allow the read-only request, the read-only requester entity is registered as a read-only blockchain user for the monitored entity, the registration granting the read-only requester entity permission to read data from the financial transaction ledger regarding transactions in which the monitored entity is recorded as a payment participant; and
the method further comprising:
receiving, from one or more read write requester entities, one or more respective read write access requests, each read write access request being a request for registration as a read and write blockchain user; and
determining whether or not to allow each read write access request, and in response to determining to allow a read write access request, registering the respective read write requester entity as a read and write blockchain user, having permission to read data from the permissioned blockchain and permission to write data to the permissioned blockchain.

13. (canceled)

14. (canceled)

15. (canceled)

16. A computing apparatus comprising memory hardware and processor hardware, the memory hardware storing processing instructions which when executed by the processor hardware, configure the processor hardware to:
receive, from a read-only requester entity, a read-only access request, being a request for registration as a read-only blockchain user;
determine whether or not to allow the read-only request, and in response to determining to allow the read-only request, register the read-only requester entity as a read-only blockchain user, having permission to read data from the permissioned blockchain in the absence of permission to write data to the permissioned blockchain, wherein
the permissioned blockchain is a financial transaction ledger recording payments between payment participants in exchange for goods or services;
the read-only blockchain user is an accounting system;
the read-only request specifies a monitored entity, the monitored entity being a user of the accounting system; and
in response to determining to allow the read-only request, the read-only requester entity is registered as a read-only blockchain user for the monitored entity, the registration granting the read-only requester entity permission to read data from the financial transaction ledger regarding transactions in which the monitored entity is recorded as a payment participant; and
the processor being further configured to:
receive, from one or more read write requester entities, one or more respective read write access requests, each read write access request being a request for registration as a read and write blockchain user; and
determine whether or not to allow each read write access request, and in response to determining to allow a read write access request, registering the respective read write requester entity as a read and write blockchain user, having permission to read data from the permissioned blockchain and permission to write data to the permissioned blockchain.

17. (canceled)

18. (canceled)

19. (canceled)

20. (canceled)

21. The non-transitory computer-readable medium according to claim 12, the method further comprising:
adding a new block to the financial transaction ledger recording a new payment between payment participants;
comparing the payment participants for the new payment with registered monitored entities of read-only blockchain users to determine that a payment participant is the monitored entity for a particular read-only blockchain user; and
notifying the particular read-only blockchain user of the new payment.

22. The non-transitory computer-readable medium according to claim 12, the method further comprising:
receiving an update request from a registered read-only blockchain user;
for blocks in the permissioned blockchain having timestamps belonging to a defined time period, identifying payments recorded in the financial transaction ledger in which a payment participant is the monitored entity for the read-only blockchain user from which the update request is received; and
responding to the update request with a notification of the identified payments.

23. The non-transitory computer-readable medium according to claim 12, the method further comprising:
upon registering the read-only blockchain user for a monitored entity, issuing the read-only blockchain user entity with a read-only certificate specific to the monitored entity;
replicating the blockchain to read and write blockchain users and to read-only blockchain users, the financial transaction ledger of the blockchain being selectively cryptographically encrypted in the blockchain with an encryption code selected per recorded payment in dependence upon the payment participants; and
the read-only certificate specific to the monitored entity being configured to decrypt the financial transaction ledger to obtain a notification of recorded transactions in which the monitored entity is a payment participant, and not to decrypt the remainder of the financial transaction ledger.

24. The computing apparatus according to claim 16, the processor being further configured to:
add a new block to the financial transaction ledger recording a new payment between payment participants;
compare the payment participants for the new payment with registered monitored entities of read-only blockchain users to determine that a payment participant is the monitored entity for a particular read-only blockchain user; and
notify the particular read-only blockchain user of the new payment.

25. The computing apparatus according to claim 16, the processor being further configured to:
receive an update request from a registered read-only blockchain user;
for blocks in the permissioned blockchain having timestamps belonging to a defined time period, identify payments recorded in the financial transaction ledger in which a payment participant is the monitored entity for the read-only blockchain user from which the update request is received; and
respond to the update request with a notification of the identified payments.

26. The computing apparatus according to claim 16, the processor being further configured to:
upon registering the read-only blockchain user for a monitored entity, issue the read-only blockchain user entity with a read-only certificate specific to the monitored entity;
replicate the blockchain to read and write blockchain users and to read-only blockchain users, the financial transaction ledger of the blockchain being selectively cryptographically encrypted in the blockchain with an encryption code selected per recorded payment in dependence upon the payment participants; and
the read-only certificate specific to the monitored entity being configured to decrypt the financial transaction ledger to obtain a notification of recorded transactions in which the monitored entity is a payment participant, and not to decrypt the remainder of the financial transaction ledger.

27. The computing apparatus according to claim 16, wherein
the permissioned blockchain is a private blockchain to which access is controlled by a financial institute.

28. The computer-implemented method according to claim 1, wherein
at least one of the read write requester entities is a point-of-sale system, and the monitored entity is a user of both the point-of-sale system and the accounting system.

29. The computer-implemented method according to claim 1, wherein
the permissioned blockchain is a private blockchain to which access is controlled by a financial institute.
